(19) United States
(12) Patent Application Publication
(10) Pub. No.: US 2013/0322952 A1
(43) Pub. Date: Dec. 5, 2013

(54) MULTI-FUNCTIONAL STYLUS

(71) Applicants: SHENZHEN FUTAIHONG PRECISION INDUSTRY CO., LTD., (US); FIH (HONG KONG) LIMITED, Kowloon (HK)

(72) Inventors: YONG-GANG ZHANG, Shenzhen (CN); KUAN-HUNG CHEN, Shindian (TW)

(73) Assignees: FIH (HONG KONG) LIMITED, Kowloon (HK); SHENZHEN FUTAIHONG PRECISION INDUSTRY CO., LTD., Shenzhen (CN)

(21) Appl. No.: 13/873,404

(22) Filed: Apr. 30, 2013

(30) Foreign Application Priority Data
May 30, 2012 (CN) 2012202476841

(51) Int. Cl. B43K 29/00

(52) U.S. Cl. CPC B43K 29/00
USPC 401/195

(57) ABSTRACT

A multi-functional stylus includes a housing defining a coupling hole, and a stylus body assembly removably connected to the housing. The stylus body assembly includes a main body, a stylus head located at one end of the main body and a pen located at the other end of the main body. Either the stylus head or the pen can be presented out of the coupling hole. A flange is formed on a peripheral surface of the main body. At least one protrusion is located on an inner surface of the coupling hole. The flange passes over the at least one protrusion and is blocked by the at least one protrusion to mount the stylus body assembly to the housing.

### BACKGROUND

1. Technical Field

The disclosure generally relates to styluses, and particularly to a multi-functional stylus.

2. Description of the Related Art

Generally, most touch electronic devices include styluses for inputting information and selecting menu options. However, typical styluses have no other uses besides being used to touch the electronic device.

Therefore, there is room for improvement within the art.

### BRIEF DESCRIPTION OF THE DRAWINGS

Many aspects of an exemplary multi-functional stylus can be better understood with reference to the following drawings. The components in the drawings are not necessarily drawn to scale, the emphasis instead being placed upon clearly illustrating the principles of the exemplary multi-functional stylus. Moreover, in the drawings, like reference numerals designate corresponding parts throughout the several views. Wherever possible, the same reference numbers are used throughout the drawings to refer to the same or like elements of an embodiment.

FIG. 1 is an exploded view of a multi-functional stylus according to an exemplary embodiment.

FIG. 2 is a partially assembled view of the multi-functional stylus shown in FIG. 1.

FIG. 3 is a schematic assembled view of the multi-functional stylus shown in FIG. 1, shown in a first configuration.

FIG. 4 is similar to FIG. 3, but shown in a second configuration.

FIG. 5 is a cross-sectional view of the multi-functional stylus along line V-V of FIG. 4.

### DETAILED DESCRIPTION

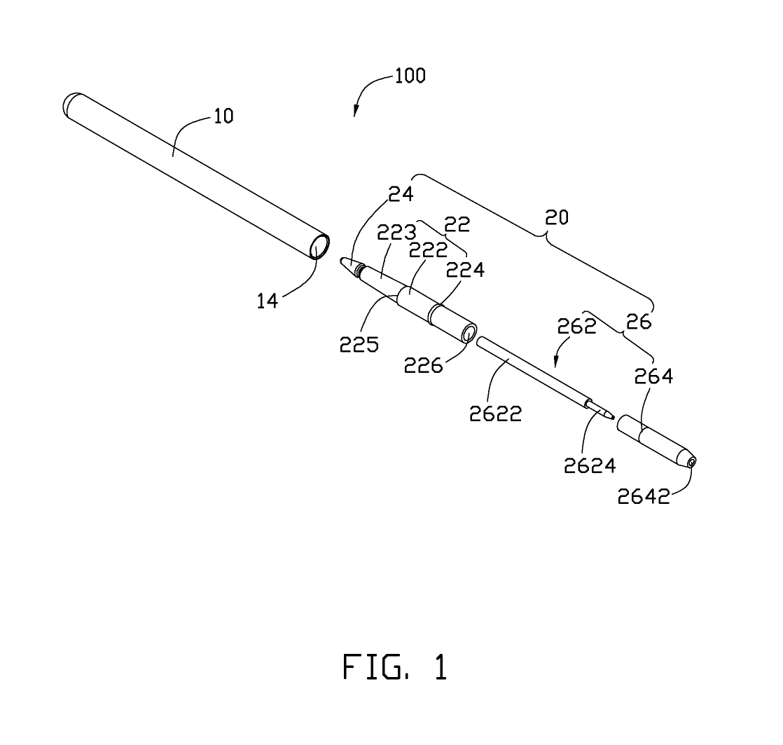

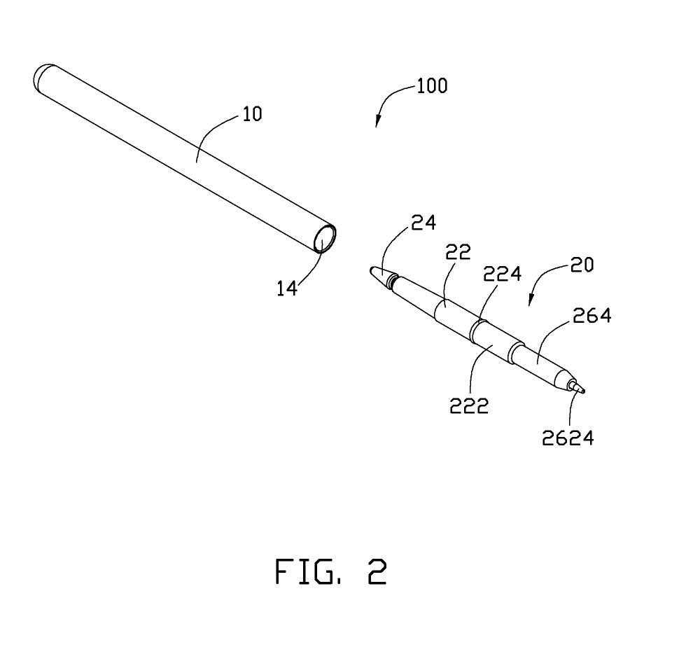

FIGS. 1-2 show a multi-functional stylus 100 which can be used to contact a touch screen of an electronic device such as a mobile phone. The multi-functional stylus 100 includes a housing 10 and a stylus body assembly 20 removably connected to the housing 10. The stylus body assembly 20 includes a main body 22, a stylus head 24 located at one end of the main body 22, and a pen 26 (e.g., ballpoint pen) located at the other end of the main body 22.

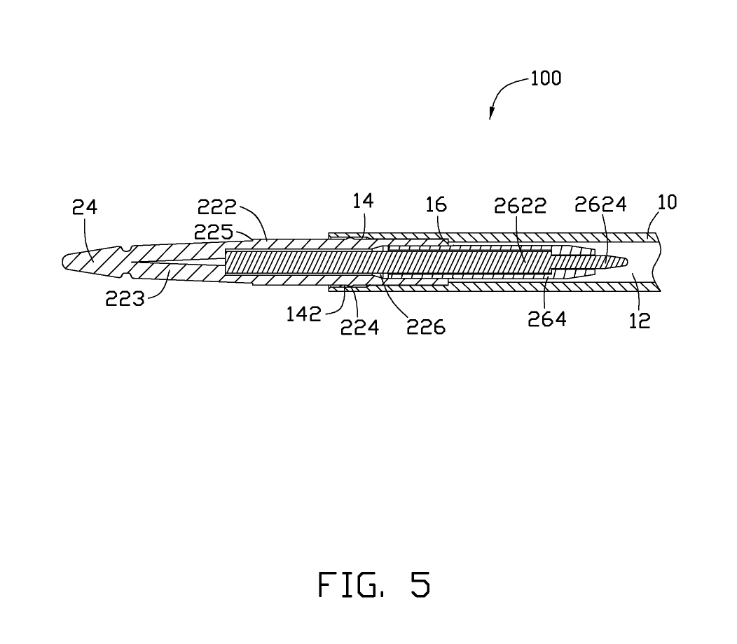

Also referring to FIG. 5, the housing 10 defines a coupling hole 14 and a receiving hole 12 communicating with the coupling hole 14. A diameter of the coupling hole 14 is larger than a diameter of the receiving hole 12. A resisting wall 16 is formed on a joint between the coupling hole 14 and the receiving hole 12. A plurality of protrusions 142 are located on an inner surface of the coupling hole 14.

The main body 22 is substantially a shaft and includes a grip portion 222, and a connection portion 223 protruding from one end of the grip portion 222. A flange 224 is formed on a peripheral surface of the grip portion 222. The grip portion 222 longitudinally defines a blind hole 226. A diameter of the grip portion 222 is larger than a diameter of the connection portion 223. An annular junction surface 225 is formed between the grip portion 222 and the connection portion 223. The stylus head 24 is connected to the connection portion 223. In the embodiment, the stylus head 24 is attached to the main body 22 by injection molding.

The pen 26 includes a pen body 262 and a shell 264. The pen body 262 includes a base body 2622 and a pen head 2624 protruding from one end of the base body 2622. The base body 2622 is partially received in the blind hole 226. The shell 264 defines a through hole 2642 allowing the pen head 2624 to pass through. The shell 264 covers one part of the base body 2622 and is retained in the blind hole 226 to hold the base body 2622 in the blind hole 226. The pen head 2624 passes through the through hole 2642 and is exposed from the shell 264.

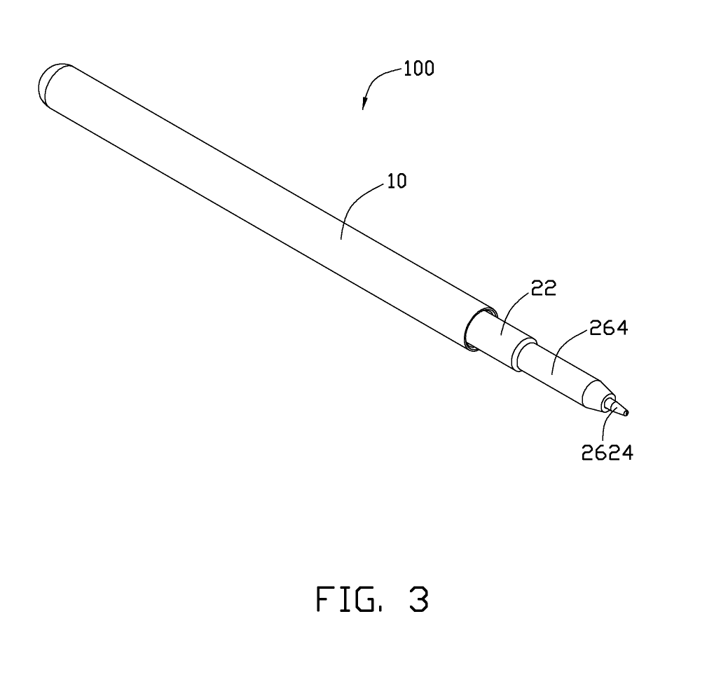

Referring to FIGS. 2-3, in assembly, the base body 2622 is partially received in the blind hole 226, and the pen head 2624 is exposed from the blind hole 226. The pen head 2624 passes through the through hole 2642 and is exposed from the shell 264. The shell 264 is retained in the blind hole 226 to hold the base body 2622 in the blind hole 226. The stylus head 24 of the assembled stylus body assembly 20 is inserted into the receiving hole 12 of the housing 10 until the junction surface 225 meets the resisting wall 16 and the flange 224 passes over the protrusions 142. Then the flange 224 is blocked by the protrusions 142. The exposed pen head 2624 may be used for writing.

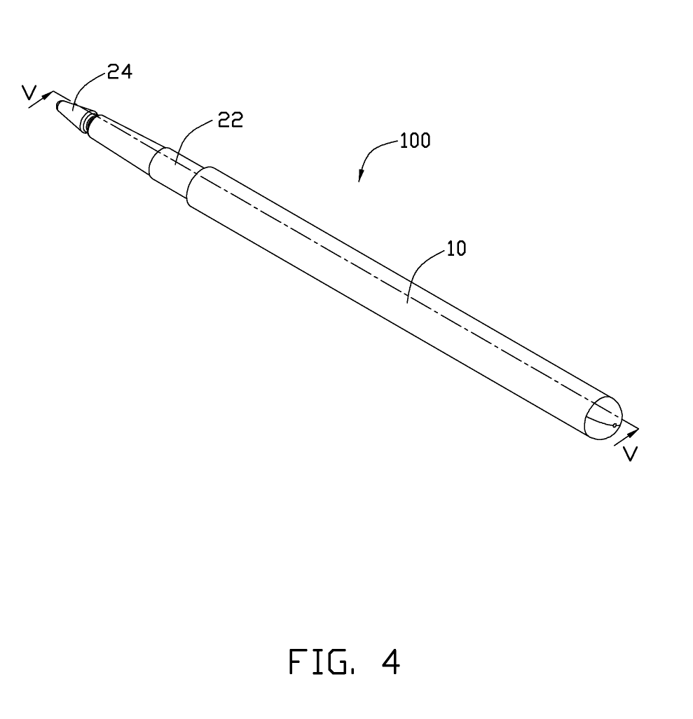

Referring to FIGS. 4-5, when the stylus head 24 is to be used on a touch screen, the stylus body assembly 20 is pulled out of the housing 10. The pen 26 is inserted into the receiving hole 12 of the housing 10 until an end of the grip portion 222 away from the connection portion 223 resists the resisting wall 16 and the flange 224 passes over the protrusions 142. Thus the stylus head 24 is presented and can be used to make contact with the touch screen.

In another exemplary embodiment, the base body 2622 can be tightly received in the blind hole 226 and the shell 264 can be omitted.

The multi-functional stylus 100 can be used for inputting on the touch screen or for writing on a medium, and it is easy to use.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in the matters of shape, size, and arrangement of parts within the principles of exemplary disclosure to the full extent indicated by the broad general meaning of the terms in which the appended claims are expressed.

What is claimed is:

1. A multi-functional stylus comprising:
a housing defining a coupling hole;
a stylus body assembly removably connected to the housing, wherein the stylus body assembly comprising: a main body, a stylus head located at one end of the main body, and a pen located at the other end of the main body; the stylus head and the pen can be selectively received in the coupling hole;
a flange is formed on a peripheral surface of the main body;
at least one protrusion is located on an inner surface of the coupling hole; the flange passes over the at least one protrusion and is blocked by the at least one protrusion to mount the stylus body assembly to the housing.

2. The multi-functional stylus as claimed in claim 1, wherein the housing further defines a receiving hole communicating with the coupling hole and a resisting wall is formed on a joint between the coupling hole and the receiving hole.

3. The multi-functional stylus as claimed in claim 2, wherein the main body resists the resisting wall when the flange passes over the at least one protrusion.

4. The multi-functional stylus as claimed in claim 1, wherein the main body comprises: a grip portion and a connection portion protruding from one end of the grip portion, the flange is formed on a peripheral surface of the grip portion, the stylus head is connected to connection portion.

5. The multi-functional stylus as claimed in claim 4, wherein the grip portion longitudinally defines a blind hole engaging with the pen.

6. The multi-functional stylus as claimed in claim 5, wherein the pen comprises a pen body, the pen body comprises a base body and a pen head protruding from one end of the base body, the base body is partially received in the blind hole.

7. The multi-functional stylus as claimed in claim 6, wherein the pen further comprises a shell, the shell covers part of the base body and is retained in the blind hole to hold the base body in the blind hole.

8. A multi-functional stylus comprising:
a housing;
a stylus body assembly removably connected to the housing, wherein the stylus body assembly comprising: a main body, a stylus head located at one end of the main body and a pen located at the other end of the main body; the stylus head and the pen can be selectively received in the housing;
a flange is formed on a peripheral surface of the main body;
at least one protrusion is located on an inner surface of the housing; the flange passes over the at least one protrusion and is blocked by the at least one protrusion to mount the stylus body assembly to the housing.

9. The multi-functional stylus as claimed in claim 8, wherein the housing defines a coupling hole and a receiving hole communicating with the coupling hole; a resisting wall is formed on a joint between the coupling hole and the receiving hole, the at least one protrusion is located on an inner surface of the coupling hole.

10. The multi-functional stylus as claimed in claim 9, wherein the main body resists the resisting wall when the flange passes over the at least one protrusion.

11. The multi-functional stylus as claimed in claim 8, wherein the main body comprises: a grip portion and a connection portion protruding from one end of the grip portion; the flange is formed on a peripheral surface of the grip portion, the stylus head is connected to connection portion.

12. The multi-functional stylus as claimed in claim 11, wherein the grip portion longitudinally defines a blind hole engaging with the pen.

13. The multi-functional stylus as claimed in claim 12, wherein the pen comprises: a pen body, the pen body comprises: a base body and a pen head protruding from one end of the base body, the base body is partially received in the blind hole.

14. The multi-functional stylus as claimed in claim 13, wherein the pen further comprises: a shell, the shell covers part of the base body and is retained in the blind hole to hold the base body in the blind hole.
